(19) United States
(12) Patent Application Publication
(10) Pub. No.: US 2016/0344725 A1
(43) Pub. Date: Nov. 24, 2016

(54) SIGNAL HAYSTACKS

(71) Applicant: William B. SEVERIN, South Orange, NJ (US)

(72) Inventor: William B. SEVERIN, South Orange, NJ (US)

(21) Appl. No.: 14/669,310

(22) Filed: Mar. 26, 2015

Related U.S. Application Data
(60) Provisional application No. 61/974,088, filed on Apr. 2, 2014.

(51) Int. Cl. H04L 29/06

(52) U.S. Cl. CPC H04L 63/0823; H04L 63/062; H04L 63/0442

(57) ABSTRACT

A method for the exchange between two computer systems, without prior exchange of any material or prior third-party endorsement, of key-pairs and signed public-key certificates for the purpose of establishing communications secure from eavesdropping or man-in-the-middle attacks; a mechanism for verifying the exchange was not subject to third-party eavesdropping or man-in-the-middle attack; and a mechanism for verifying future communication using the exchanged material is occurring between the two computer systems involved in the original exchange.

### CROSS REFERENCE TO RELATED APPLICATION

Reference is made to Provisional Patent Application Ser. No. 61/974,088, filed on Apr. 2, 2014, which application is incorporated herein by reference in its entirety. Priority thereof is claimed herein.

### BACKGROUND OF THE INVENTION

### Field of the Invention

The present invention relates to public-key cryptosystems, and more particularly, to a process of a verifiably-secure key-exchange between two sites, with no previous exchange of any material between them.

Public-key cryptosystems include identified principals with a pair of keys including a public-key and a private-key, a public-key certificate, a certificate authority, and relying principals.

A public-key infrastructure (PKI) refers to the collection of entities, data structures, and procedures used to authenticate public-key certificates. A traditional PKI comprises a certificate authority, public-key certificates, cryptographic algorithms, and procedures for managing and using the public-key certificates.

Encryption is a process of conversion of information from a readable state to apparent nonsense. Encryption is based on mathematical theory and computer science practice; implementations of encryption, called cryptograph algorithms, are designed around computational hardness assumptions, making such algorithms hard to break in practice by any adversary. It is theoretically possible to break such a system but it is infeasible to do so by any known practical means.

A Pre-shared key (PSK) is a secret-key used in symmetric encryption known to two or more principals for the purpose of encrypting data in a way that can only be decrypted by another principal with the same key. Pre-shared keys suffer from the problem of how to exchange the secret key to be used to establish a secure communication channel without first having established a secure channel over which to share the secret. For this reason, pre-shared keys are often exchanged over a different, off-line channel of communication subject to its own security-related challenges. PSKs are typically not used in PKIs.

A private-key is a code associated exclusively to a single principal; it is not disclosed to any other principal on the network. The private-key is a carefully guarded secret.

A public-key is a code associated exclusively to a single principal; it may be made known, and shared with other principals on the network.

A key-pair consists of a public-key and private-key with a useful mathematical relationship between the keys that make the key-pair useful for encryption. A public-key in a key-pair can be used with the proper cryptographic algorithm to convert plain-text or plain-bytes into cypher-text or cypher-bytes in such a way that only the private-key in the same key-pair can unencrypt to the same original plain-text or plain-bytes.

A session-key is a secret-key used in symmetric encryption that can be used only for the current communication or session. A session key can be randomly generated and exchanged in a secure way through the use of a key-pair to encrypt the randomly generated session-key on one side with the public key and transmit the resulting cipher-text to the other side where it can be decrypted only with the matching private-key. Session keys are often used for long-running communication because they are often faster than public-private-key encryption and can be exchanged securely without the problems of PSKs. Session keys are disposed of after use, limiting the impact of a brute-force attack to the data exchanged in a single session and not providing access to any past or future communication.

Forward secrecy (also known as perfect forward secrecy or PFS), is a property of key-agreement protocols that ensures that a session-key derived from a set of long-term keys will not be compromised if one of the long-term keys is compromised in the future. The key used to protect transmission of data must not be used to derive any additional keys, and if the key used to protect transmission of data was derived from some other keying material, that material must not be used to derive any more keys. Thus, compromise of a single key will permit access only to data protected by a single key.

Public-key certificates, or just certificates, associate identifying information for a principal to a public-key and often include a unique identity for that certificate and a certificate validity date range.

The identifying information in a public-key certificate may also be referred to as the subject of the certificate.

A cryptographic digest is an operation performed against input data to produce a unique output. Digests do not contain all the information of the input data, so they cannot be reversed to the original plain-text like encryption cipher-text. Cryptographic digests have the characteristic that even small changes to the input data will result significantly different digests. A digest can therefore be used to verify the input data has not changed, even in small ways, if it produces the same digest for the same cryptographic algorithm and input data and secret information.

A digital signature is a variation of cryptographic digest which uses a private-key for digestion but uses the public-key for validation. A digital signature has the property of a digest in asserting that the plain-text has not been altered since the digital signature was created by also adds the assertion that the signer had knowledge of the private-key and therefore is the identified principal associated with a valid public-key certificate.

A certificate authority is a trusted principal which asserts the accuracy of a public-key certificate. The public-key certificate is a confirmation or validation by the certificate authority that the public-key contained in the certificate belongs to the person, organization, server or other entity noted in the certificate.

Identity verification is the process performed by a certificate authority to confirm the identity of a principal before digitally signing a certificate to assert the public key belongs to the identified principal. Verification often involves sending an email to the email address in the registered domain record which is known to be controlled by the domain owner. An appropriate response from that domain email address is used as validation. This type of verification, often the most commonly used, is subject to numerous attacks including DNS and MX-record attacks, DNS registration social engineering attacks, email interception, and IP address spoofing. Extended validation may involve meeting the principal or system owner and verifying the identifying information against other legal documentation. Due to the extra effort, extended validation costs more and is less common. The quality of verification depends on the process followed by the certificate authority and the reputation of the certificate authority to do a good job when performing extended verification. After validation of the identity of the subject for the certificate, a certificate authority will digitally sign the certificate to make the assertions a digital signature provides.

An identified principal owns a key-pair the public-key of which is contained in a public-key certificate verified by a certificate authority.

A relying principal is a principal that relies on the public-key certificate to establish the identity of the principal with whom they are communicating is the identified principal with whom they expect to be communicating and to establish a secure channel of communication.

A certificate may be revoked if the association between a public key and an identity becomes invalid or the private-key in the key-pair becomes compromised. Identity information may become invalid because the attributes no longer apply to the owner. A private-key becomes compromised if it becomes known to any principal other than the identified principal. Revoking a certificate may be accomplished through the use of certificate revocation lists and certificate validity date ranges.

A certificate validity date range is part of a public-key certificate that establishes a date and time before which a certificate is not yet valid and a date and time after which a certificate is no longer valid. Most public-key certificates include a validity date range to ensure the certificate authority revalidates the subject of a certificate on a certain basis and to allow certificates to be removed from certificate revocation lists after a certificate's expiration date.

A certificate revocation list (CRL) is a list maintained by the certificate authority of certificate identities that are no longer asserted by the certificate authority but still inside the certificate validity date range. Certificate revocation lists become longer if certificates need to be invalidated before the certificate's listed expiration date. Certificate revocation lists become shorter as certificates are removed from the list when passing their expiration date.

A certificate-chain includes two or more public-key certificates, each certificate being digitally signed by the next certificate in the chain except for the last certificate which is generally the certificate of a certificate authority. A certificate-chain is valid, and the first certificate can then be trusted, if all of the certificates in the chain are valid, if the relying principal trusts the signing certificates in the chain and recognizes the authority of those certificate's identified principals to act as a certificate authority for the certificates they digitally sign. If any of the certificates in the chain has expired or is listed in a CRL, the certificate chain must not be used as the compromise or expiry of any certificate could compromise the other certificates in the chain.

On-line herein refers activities that occur on or over a network inclusive of the PKI.

Off-line herein refers to activities which occur more infrequently and involve activities that do not require the use of the network. Establishment or dissolution of public-key certificates, the issuing or revocation of public-key certificates and distribution of a CRL are often performed off-line. A traditional certificate authority is off-line, issues CRLs off-line, and places the CRLs in a directory for on-line retrieval. By downloading the CRLs and certificates for trusted certificate authorities most certificate validation can be performed by the relying principal off-line subject to a potential for incorrect validation due to stale data based on the frequency of updates.

Authentication is an on-line process of establishing a principal as an identified principal. In a PKI, authentication can be established by demonstrating knowledge of the private-key which is known only to the identified principal for a valid public-key certificate. In one realization of authentication, a challenge is issued from the relying party including randomly generated plain-text which the identified principal must encrypt with the private-key. The relying principal can depend on the identity of the principal matching the subject of a public-key certificate if the public-key is able to successfully decrypt the challenge response from that principal using the certificate public-key. The relying principal must also verify the current date and time are inside the certificate validity date range and the certificate is not included in any certificate revocation list. Authentication may be compromised if the private-key is not maintained securely but not yet listed on a CRL, if the assertion made by the certificate-authority was not properly verified, or if the relying party did not properly verify the validity of the certificate or certificate chain.

An on-line certificate status protocol (OCSP) operates by permitting the verifier of the public-key certificate to ask the certificate authority if the certificate is currently valid. The certificate authority responds with a signed statement indicating validity or revocation. The OCSP allows CRLs to be avoided but requires the verifier to query the certificate authority as part of the transaction that employs the public-key certificates. Querying the certificate authority through the OCSP protocol increases the time it takes to perform a transaction. The OCSP scheme is vulnerable to a denial-of-service attack, where the attacker floods the certificate authority with queries. Responding to each query is computationally expensive, because each response requires a digital signature. The verification of the digital signature must also be carefully implemented as it depends on the certificate of the certificate-authority which needs to be periodically verified and only the certificate of the OCSP certificate authority should be used in the verification process to avoid active man-in-the-middle attacks.

A secure communication channel is a channel for the exchange of information between two principals protected by encryption from interception by a third-party for capturing the plain-text information or changing the intended information before arriving at the opposite end of the channel. A secure communication channel may also involve authentication of one or both principals to assert that information is coming from or going to the intended identified principal. Encryption for a secure communication channels is typically established through the use of a pre-shared key (PSK) or the use of public-key certificates and a hand-shake process to authenticate identified principals.

The Hsu et al., U.S. Pat. No. 5,982,898 discloses a certification process that combines a registration authority with a certification authority that issues short-lived certificates for a user. The registration authority checks the user's proof of identity to confirm that the user is bona fide, then issues a password for the user that enables the user to access the certification authority. When the bona fide user desires a short-lived certificate from the certification authority, the user and certification authority must complete a password verification process. Next, the certification authority proceeds to develop and sign the short-lived certificate. The use of password protection for accessing the certification authority and the certification authority having to develop the short-lived certificate add complexity to the authentication process and can create a bottleneck in the certification process while potentially reducing the overall security to the weakest implementation of the proof-of-identity, the password issuance, or the short-term certificate authority.

The International Patent Application by Hur, et al., international publication number WO 99/35783, discloses a client-side public-key authentication method and apparatus with short-lived certificates. The Hur, et al. patent application discloses a key distribution center that stores the user's private/public key pair in association with an identifier of the user, and upon request, issues short-lived certificates certifying and re-certifying the user's public key. According to this scheme, the user must share the user's private/public key pair with the key distribution center, which involves sending the user's private key over the network. For such a shared key-pair paradigm to be practical, it must address security issues related to transmitting the user's private-key over the network which it does not.

The Corella et al., U.S. Pat. No. 6,763,459 discloses a process to issue on-line short-lived public-key certificates from an on-line certificate authority but requires a long-term public-key certificate which is exchanged in an off-line manner first. The patent avoids having to exchange the private-key by reusing the public-key from the long-term public-key certificate on the short-lived public-key certificate which would require another off-line exchange if the private-key were ever compromised and whenever the long-term certificate should expire. Further, the short-term public-key certificate is issued by the short-term certificate authority, which requires the addition of another trusted certificate authority to the relying party's trusted authority list and it can prevent the relying party from knowing the certificate authority of the long-term certificate which is in-fact providing the identity verification guarantee.

The use of long-term server-side public-key certificates requires the relying principal to trust the identified principal to properly maintain the secrecy of the private-key associated to the public-key certificate. Loss of the private-key by the identified principal leaves the relying principal exposed to man-in-the-middle attacks where the compromised public-key certificate is used to establish communication from the relying principal to the attacker. The attacker can then relay the information to the identified principal by pretending to be the relying party. All information in both directions could then seen by the attacker. The attacker could also setup new locations pretending to be the identified party to extract information from the relying party without relaying information to the true identified principal.

The use of long-term server-side public-key certificates leaves the improbable, but theoretically possible, chance of a well-funded organization or government entity to brute-force attack the private key from communications over the secure channel. While the brute-force attack currently resides in the billions of years, it is possible that technological advancements, grids consisting of millions of parallel processors, or weaknesses in the random number generator (RNG) selected for key construction could reduce the brute-force attack against a single key to be achievable inside a window of opportunity for the attacker.

The use of a third-party certificate authority requires trust from the relying principal that the certificate authority is performing identity verification properly. Incorrect identification of an attacker as the true identified principal can result in the same types of attack as a compromised private-key.

The use of a third-party certificate authority requires trust from the relying principals that the certificate authority is who they claim to be. Any attack that successfully compromises the private-key of the certificate authority can be immediately used to issue new certificates resulting in the same attacks as an improper verification but with a scope to all identified principals certified by the certificate authority.

The use of long-term certificates and CRLs places a burden on the certificate authority and relying principals to ensure proper validation of all certificates. CRLs must be kept up to date and all certificates in a certificate-chain must pass certificate validity date range, CRL checks, and verification of the certificate entire chain of certificate signatures in the chain. The time between it being discovered that a private-key has been compromised, added to the CRL and the time that CRL is updated on the relying principal site to reject compromised public-key certificates is another vulnerability. Interception and manipulation of the CRL could result in compromised certificates appearing to remain valid.

Compulsion by an external authority or other third-party through duress, to reveal the private-key of either the identified principal or the certificate authority can be performed without alerting the relying principals of such compromise, leaving the relying party exposed to an insecure channel without realizing it has been compromised.

The identified-principal's use of a single private-key for all relying principals in existing PKIs allows the compromise of all relying principals with the compromise of a single private-key.

For reasons stated above and for other reasons presented in greater detail in the Description of the Preferred Embodiment section of the present specification, there is a need for an improved initial key-exchange process which can be verified as having occurred over a secure communication channel.

### SUMMARY OF THE INVENTION

The present invention relates to a process of verifiably-secure exchange of a public-private key-pair and public-key certificate between two sites, with no previous exchange of any material between them, in an infrastructure employing short-term public-key certificates wherein the responsibilities for key-pair generation and public-key certificate signing are performed by the client-site and transferred to the server-site eliminating the need for separate certificate authority as the client is capable of trusting certificates issued by itself, resulting in a trust no one solution with forward-perfect security for secure communications with an identified principal.

### BRIEF DESCRIPTION OF THE DRAWINGS

FIG. 1 illustrates the components which comprise the client-site

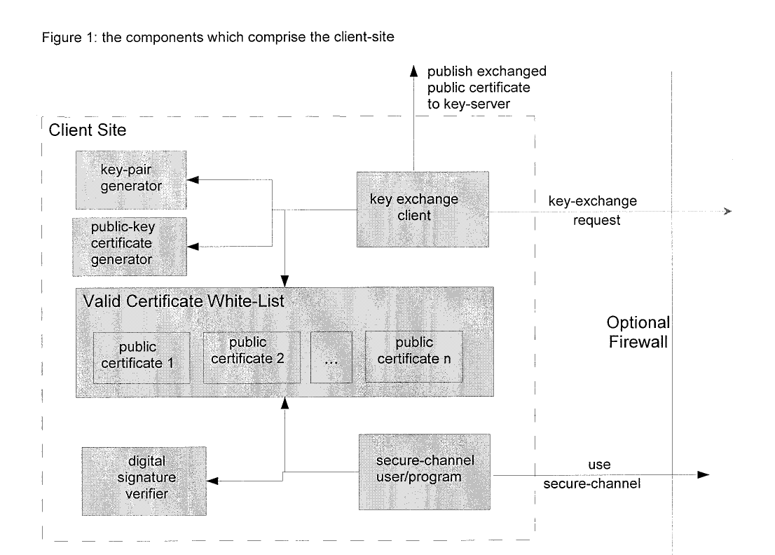

A key-exchange server for accepting incoming requests which uses the key-pair generator and public-key certificate signer to create the cryptographic material, the certificate being published to a key-server and added to an internal white-list of valid certificates, the key-pair and certificate being returned in the response to the request. A program which uses the server-site, authenticating against the internal white-list and periodically verifying matching digital signatures to check for tampering.

FIG. 2 illustrates the components which compromise the server-site

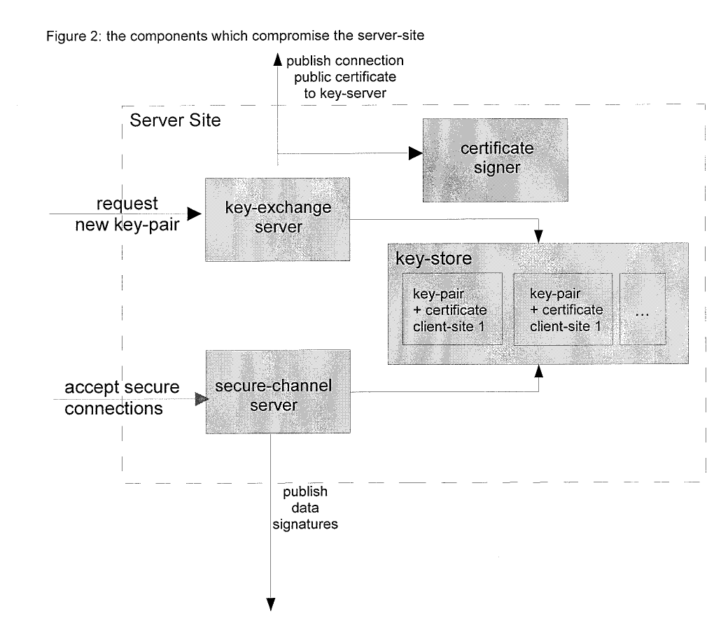

A key-exchange client that requests key-pair exchanges from one or more server-sites and places the key-pair and public-key certificate into a key store to establish one or more secure communication servers that use the to authenticate the client-site and encrypt the communication channel between the client-site and server-site.

FIG. 3 illustrates a network topology diagram which shows the client-site, server-site, and key-server(s).

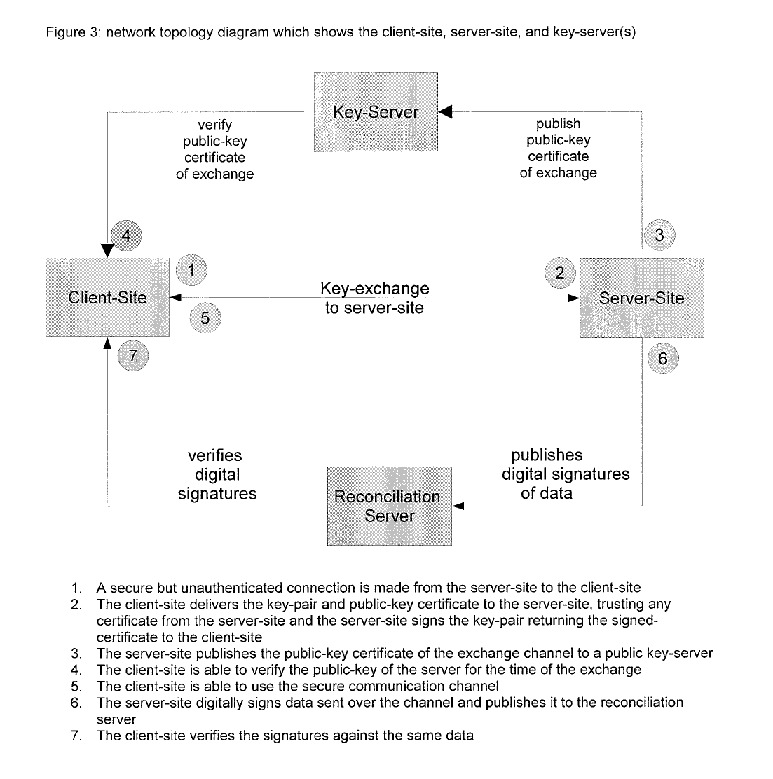

FIG. 4 illustrates a sequence diagram showing the order of operations in the key-exchange protocol between the client-site and server-site.

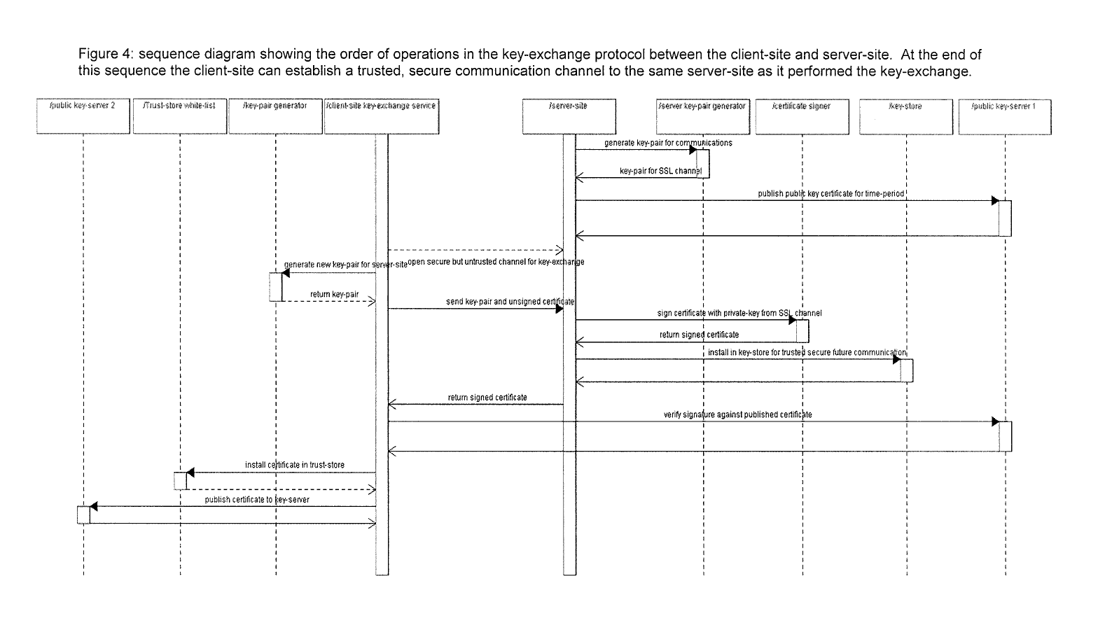

FIG. 5 illustrates a sequence diagram showing the order of operations on the client-site to check for man-in-the-middle attacks

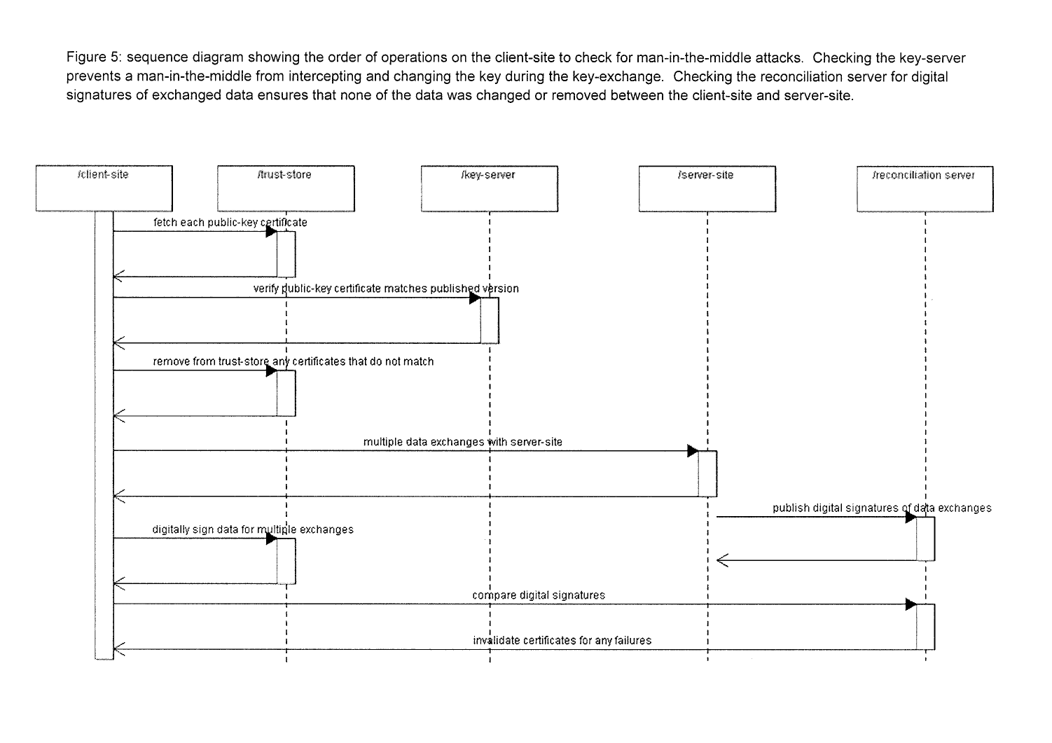

### DESCRIPTION OF THE PREFERRED EMBODIMENTS

The system and method of the present invention advantageously enable a secure communication channel to be created with a unique key-pair and public-key certificate per-client (relying principal) under the control of the client-site as certificate authority rather than being under control of the server-site (identified principal) or a third-party certificate authority. Under this invention, generation and validation of all key-pairs and public-key certificates remain under the control of the relying principal in a location hereafter referred to as a client-site and includes a secure mechanism for replacing the key-pairs and public-key certificates on the other side of the connection for the identified principal, hereafter referred to as the server-site.

An instance of the system comprises one of a plurality of client-sites and one or more or a plurality of server-sites. The client-site contains a key-pair generator and a means to create new public-key certificates associated to a specific server-site, with an expiration date and time; a certificate-provisioning service to listen for incoming requests for new server-site certificate installation; a mechanism for publishing the public-key certificate to a well-known third-party public-key server with a digital signature generated from the key-pair used for securing the exchange communication channel. The client-site contains a mechanism to periodically check the published public-key certificate and the signature of that certificate using the unpublished key-pair used during the key exchange. The client-site contains a mechanism to create digital signatures of data sent over the secure communication channel and compare those signatures to those created on the server-site to ensure data successfully reached the other side without being modified or dropped by a man-in-the-middle.

The server-site contains a mechanism to accept a new key-pair and public-key certificate from a client-site and sign the exchanged certificate over a secure channel and later use that key-pair to provide a cryptographically-secured channel when the client-site initiates future requests. The server-site also contains a mechanism to check the well-known third-party key server to raise alerts if the installed key-pair does not match the public-key certificate published by the client-site or if the signature on that certificate does not validate with the public key used during the key exchange. The server-site contains a mechanism to create digital signatures of data sent over the secure communication channel and publish those signatures to a reconciliation server.

A method for installing and enabling use of a certificate at a server-site comprises the steps of the client-site sending a request to the server-site, for which the server-site has installed a secure communication channel with a separate public-key certificate, the selection of a public-private key certificate from the client-site which may be generated at the time of exchange for this purpose, and the publishing of the public-key certificate, signed by the private-key of the key-pair used to secure the communication channel of the exchange, to one or more key-servers after the exchange. The server-site accepts the public-private key and public-key certificate from the client-site over a secure communication channel encrypted using a separate key-pair used only for this one-time exchange. The server-site keeps all cryptographic material in-process, never writing it to an external store or process and has the ability to compare the current public-private key at a fixed interval to the last published public-key certificate at the key-server. When comparing the currently installed public-key to the last published public-key for the same subject signed by the same server-site, if any details differ, it is indicative that either a man-in-the-middle introduced a new public key during the exchange in order to intercept messages in the future or that an attacker has tricked the client-site into performing a new key-exchange with it instead of the correct server-site. Since the man-in-the-middle does not have the server-site's key-exchange private-key, it must introduce a different key-pair to fulfill the key-exchange protocol with the server-site. It must then overwrite the published public-key from the server-site, which would be detectable by the client-site, or it must leave the published public-key alone which is detectable by the client-site. If everything matches, the server-site is now able to be certain that all future communication using the key-pair it received must be from the same server-site that performed the initial key-exchange because only that server-site has the private key to publish the signed certificate with the public-key used during the key-exchange to secure the key-exchange channel of communication.

After an initial successful key exchange has been verified, a simplification can be performed to the verification protocol for future scheduled key-exchanges by maintaining the original key in the client-site white-list until the exchange is verified. The client-site may connect to the server-site using a communication channel secured by the last key-exchange and a second channel using the new key-pair exchanged. The client-site can then use the previously verified key channel to confirm with the server-site the public-key of the new key-pair exchange. This eliminates the need for a third server, the key-server, for all subsequent key-exchanges except in the case that the server-site has been compromised, in which case the full protocol should be re-performed after a proper security evaluation of the compromised server-site.

The client-site will schedule with a certain time-period or in relation to certain trigger-events the replacement of server-site cryptographic materials with high enough frequency to eliminate long-term private-key storage and time-bound the risk of private-key compromise either through inadequate security measures as described above or a successful brute-force attack as described above. By assigning ownership of the certificate-generation and certificate authority to the client-site, this invention establishes a trust-no-one (TNO) solution—the client has to trust no one beyond itself and can time-box this self-trust through a regular reissuance of certificates. By eliminating the cost and time required to involve off-line certificate authority activities, certificates can be rotated out with a high-frequency invalidating any one-time private-key leakage. The computational-expense of repeated effort to break the new certificate keys through a brute-force attack would remain high for the attacker but there would be no-cost to the client to rotate out the private-key being attacked. The computational-expense of brute-force attacking each client-site individually over a period of time would increase exponentially relative to the frequency of key-pair rotation. For example, if a client-site performed a key-exchange every thirty minutes, the cost to brute-force attack all key-pairs to obtain the data for one year would increase by approximately 2̂14 (365 days*24 hours/day*2 periods/hour=17520 which is approximately 2̂14). The computational-expense of brute-force attacking all relying principals on any one server-site would increase linearly with each new client-site in addition to the exponential cost increase to attack over a period of time. The computational-expense of attacking relying principals across more than one server-site would similarly increase linearly for each additional server-site.

The system and method of this invention eliminates the dramatic increase in risk associated with a compromised certificate authority certificate as described above when compared to the compromise of an identified principal certificate compromise, as the client-site is able to generate a new signing certificate (certificate authority certificate) at any time. The impact of the loss of the certificate authority certificate private-key is further mitigated through the use of a known white-list of certificates instead of a black-list approach used by CRLs. Any certificates issued by a compromised signing certificate would not appear in the white-list and therefore never be valid.

A server-site may have multiple public-key certificates installed, but each certificate corresponds to only a single client-site. The client-site may issue many public-key certificates, but each certificate is tied to a single server-site as the identified principal. One certificate therefore corresponds to a possible secure connection between the one client-site acting as the certificate authority of that certificate and the one identified server-site which is the identified principal on that certificate. The compromise of any one private-key does not compromise all relying principals that use a server-site as described above, but instead only impacts a single client-site. Brute-force attacks cannot be applied against the extremely high-value certificate authority private-key to open the possibility of man-in-the-middle attacks against all relying principals across all identified principals with public-key certificates issued by that single certificate-authority because the certificate authority responsibility has been given to each relying party individually to secure each identified principal only for that single relying party.

By treating any unknown certificate as invalid or revoked, the client-site has no need to maintain a CRL as described above, but instead maintains a very short white-list of valid certificates. Instead of issuing a CRL, the client simply “forgets” invalid certificates through removal from the known list of certificates and goes through a process of generation and certificate exchange with the server-site before opening the next secure communication channel to that server-site. The size of the remembered public-key certificates (the white-list) is limited in size to the number of server-sites used by one client-site and may be as small as zero if the client-site is has not yet establish any secure connections to a server-site. The white-list grows with each key-pair and certificate exchange to a server-site. The white-list may be pruned through a least-recently used algorithm or reduced to zero on a restart as a new certificate can be generated for any forgotten server-sites.

By moving the generation of key-pairs and certificate authority responsibilities of the server-site public-key certificates to the client-site, any legal compulsion or illegal duress must be applied against the client-site to obtain the private-key as described above necessarily alerting the relying party that such compulsion or duress has occurred. When such compulsion or duress stops, the client-site simply forgets all issued certificates invalidating any losses incurred while under duress or compulsion to maintain forward-perfect secrecy.

Preferred implementations of this invention will keep all private-keys in volatile-, non-persistent storage and replace those private-keys frequently to reduce the likelihood of the private-key being compromised and to limit the data exchanged with any single key-pair to limit the scope should compromise occur. By maintaining the exchanged key-pair only in volatile storage on the server-site the risk of private-key compromise is minimized as the private-key must be in volatile memory to be used but does not exist anywhere external to the server-site process to provide additional mechanisms for compromise. The server-site hardware providers could not be compelled to give access the private-keys as they are not in an accessible location and the compromised keys would be invalidated within a very short timeframe, such as thirty-minutes. It would require a sustained, sophisticated attack against volatile memory at a hardware level would be able to achieve sustained access to the private-keys for a single server-site, the result of which would be limited to a man-in-the-middle attack for that particular channel on that particular server-site. All current cryptographic techniques which use symmetric-keys or key-pairs are vulnerable to such an attack, so this is not a weakness unique to the key-exchange invention, and is mitigated by other security practices such as firewalls, at-rest data encryption, secure-storage requiring local physical proximity to access, anti-virus and anti-spyware detection programs. These other security practices should be applied for the protection of the client-controlled private-keys and the server-site private-keys held in volatile memory, but are outside the scope of this invention.

Any one-time loss of private-keys on either the client-site or any server-site would correct itself in the next key-exchange. Only an undetected, on-going loss of control of the protection of all private-keys on the client-site itself would result in unlimited risk. The previous statement is the equivalent to the client being unable to trust itself, in which context no communication can be secure as the data would have been available for compromise before even being communicated.

1. A method for distributing key-pairs and signed public-key certificates from a client-site to a server-site for the purpose of establishing secure communications between the sites, comprising:
providing a client-site request to the server-site to request initiation of the key-exchange protocol;
providing a connection between the client-site and the server-site;
establishing a secure connection using standard PKI protocols;
generating the public-key certificate used for the connection by the server-site;
accepting as trusted with the client-site any public-key during the handshake from the server-site that matches an expected subject for the server-site but which may not reside in a client-site trust-store;
generating the public-key certificate used for the connection by the server-site;
accepting as trusted with the server-site any public-key during the handshake from the client-site that matches the expected subject for the client-site but which may not reside in the server-site trust-store;
generating a new key-pair on the client-site or through a key-generator available to the client-site;
generating a public-key certificate with the subject set to the server-site identity and the public-key being from the generated key-pair;
publishing from the client-site an expected public-key certificate to one or more well-known public-key services;
sending the new key-pair from the client-site to the server-site;
installing the new key-pair into a key store of the server-side;
returning a public certificate from the server-site to the client site using the private key of a communication channel to sign the exchanged key-pair;
setting up a secure server socket on the server-site using the new key-pair for communication with the client-site; and
installing the public-key certificate into a white-list trust-store of the client-site.

2. A method for verifying the exchange of a key-pair between a client-site and a server-site, comprising:
checking, on a repeating basis, on the server-site a currently installed key-pair and expected subject against a last published public-key certificate in a key-server;
sending an alert from the server-site to the client-site if an installed public-key does not match the published public-key;
sending an alert from the server-site to the client-site if checking the public-key is not possible;
checking, on a repeating basis, on the client-site any currently white-listed public-keys in a client-site trust store against last published public-key certificates in the key-server and invalidating any certificates that do not match or are not found.

3. A method for verifying a secure communication channel to be free of active man-in-the-middle-attacks which alter content or prevent the content from reaching an intended server-site, comprising:
publishing the server-site certificate containing a public key used for SSL communication channels for a key exchange for each time window between generating new key-pairs;
verifying by the client-site the signature on a returned certificate from the key-exchange as matching a published public certificate published by the server for a time-window of the key exchange;
preparing with the server-site a digital signature of the most recent transmissions from the client-site;
publishing with the server-site the digital signature and time-window of data to a shared place accessible also to the client-site;
requesting from the client-site a digest or digital signature of last requests;
retrieving the digital signature with the client-site from a shared place for a matching time-window;
raising with the client-site an alert of potential man-in-the-middle attack if the digest fails to match if an active man-in-the-middle has different keys than expected, an active man-in-the-middle has diverted or modified any data reaching the server-site, digital signatures have been published from the man-in-the-middle but events have been also published from the real server-site, and an optional and less-frequent extended verification is performed by a user when an alert is raised or periodically to ensure the public key on the server-site key-store matches the public-key in the client-site trust-store, to ensure the server-site is running all reconciliation processes and to validate a checksum of binaries to ensure the binaries have not been changed.
